(19) United States
(12) Patent Application Publication
(10) Pub. No.: US 2017/0218691 A1
(43) Pub. Date: Aug. 3, 2017

(54) RETAINERS AND RETAINER KITS FOR PREHUNG DOOR ASSEMBLIES AND RELATED METHODS

(71) Applicant: Ideal Door Components Incorporated, West Linn, OR (US)

(72) Inventors: Charles R. Sales, West Linn, OR (US); Valorie Kirchem, West Linn, OR (US); Bonnie Deyoe, Oregon City, OR (US)

(21) Appl. No.: 15/422,206

(22) Filed: Feb. 1, 2017

Related U.S. Application Data
(60) Provisional application No. 62/290,296, filed on Feb. 2, 2016.

(51) Int. Cl. E06B 7/28; E06B 1/52

(52) U.S. Cl. CPC E06B 7/28; E06B 1/52

(57) ABSTRACT

Retainer kits for prehung door assemblies comprise a plug portion and a clip portion. The plug portion is sized to extend from a face bore, through an edge bore, and into a strike bore of the prehung door assembly. The plug portion includes at least a first passage extending transversely through the plug portion. The clip portion includes two or more legs including a first leg and a second leg that is spaced apart from and generally parallel to the first leg, and a bridge that interconnects the first and second legs. The first and second legs are spaced and sized to extend on opposed sides of a strike jamb of the prehung door assembly, with one of the first and second legs extending through the first passage of the plug portion. Prehung door assemblies and methods of retaining prehung door assemblies also are disclosed.

### RELATED APPLICATION

This application claims priority to U.S. Provisional Patent Application No. 62/290,296, entitled “RETAINERS AND RETAINER KITS FOR PREHUNG DOOR ASSEMBLIES AND RELATED METHODS,” which was filed on Feb. 2, 2016, and the disclosure of which is incorporated herein by reference.

### FIELD

The present disclosure relates to retainers and retainer kits for securing prehung door assemblies during shipping and installation and related methods.

### BACKGROUND

Prehung door assemblies include doors that are preinstalled on and hinged to a door frame for ease of installation. For example, prehung door assemblies are regularly used in the construction of new homes and significantly reduce the labor required for installing a door on site. Moreover, prehung door assemblies typically are prepared for installation of lock sets, but are not typically fitted with the knobs, striker plates, latches, etc., as these hardware items typically are custom selected by the end user. Accordingly, there is a need to secure the non-hinged edges of doors to the corresponding door frames to facilitate handling and shipping of prehung door assemblies without the doors being unwieldy and/or damaged due to swinging freely on the hinges.

### SUMMARY

Retainer kits for prehung door assemblies, prehung door assemblies, and methods of retaining prehung door assemblies are disclosed.

Retainer kits comprise a plug portion and a clip portion. The plug portion is sized to extend from a face bore, through an edge bore, and into a strike bore of a prehung door assembly. The plug portion includes at least a first passage extending transversely through the plug portion. The clip portion includes two or more legs including a first leg and a second leg that is spaced apart from and generally parallel to the first leg, and a bridge that interconnects the first and second legs. The first and second legs are spaced and sized to extend on opposed sides of a strike jamb of the prehung door assembly, with one of the first and second legs extending through the first passage of the plug portion.

Prehung door assemblies comprise a door frame, a door, and a retainer. The door frame includes a hinge jamb, a header, and a strike jamb that defines a strike bore. The door is hinged to the hinge jamb and defines a face bore and an edge bore that is aligned with the strike bore of the door frame. The retainer is formed from a retainer kit with the plug portion extending from the face bore, through the edge bore, and into the strike bore.

Methods of retaining prehung door assemblies comprise inserting a plug portion into an edge bore and a face bore of a door of a prehung door assembly; following the inserting, aligning the door with a strike jamb of the prehung door assembly; following the aligning, translating the plug portion into a strike bore of the prehung door assembly so that the plug portion extends from the face bore, through the edge bore, and into the strike bore; and following the translating, securing the plug portion in place with a clip portion.

### BRIEF DESCRIPTION OF THE DRAWINGS

FIG. 1 is a perspective view of a prehung door assembly.

FIG. 2 is a schematic top view diagram representing retainer kits according to the present disclosure.

FIG. 3 is a schematic top view diagram representing retainers according to the present disclosure, with the retainers including a two-legged clip portion, together with a prehung door assembly having a fully routed strike bore and with the retainers retaining the prehung door assembly in a closed configuration.

FIG. 4 is a schematic top view diagram representing retainers according to the present disclosure, with the retainers including a two-legged clip portion, together with a prehung door assembly having a partially routed strike bore and with the retainers retaining the prehung door assembly in a closed configuration.

FIG. 5 is a schematic top view diagram representing retainers according to the present disclosure, with the retainers including a three-legged clip portion, together with a prehung door assembly having a fully routed strike bore and with the retainers retaining the prehung door assembly in a closed configuration.

FIG. 6 is a schematic top view diagram representing retainers according to the present disclosure, with the retainers including a three-legged clip portion, together with a prehung door assembly having a partially routed strike bore and with the retainers retaining the prehung door assembly in a closed configuration.

FIG. 7 is an isometric view of an example of a retainer kit according to the present disclosure.

FIG. 8 is a top view of the plug portion of the retainer kit of FIG. 7.

FIG. 9 is a front view of the plug portion of the retainer kit of FIG. 7.

FIG. 10 is an end view of the plug portion of the retainer kit of FIG. 7.

FIG. 11 is a top view of the clip portion of the retainer kit of FIG. 7.

FIG. 12 is a side view of the clip portion of the retainer kit of FIG. 7.

FIG. 13 is an isometric view of another example of a retainer kit according to the present disclosure.

FIG. 14 is a top view of the plug portion of the retainer kit of FIG. 13.

FIG. 15 is a front view of the plug portion of the retainer kit of FIG. 13.

FIG. 16 is an end view of the plug portion of the retainer kit of FIG. 13.

FIG. 17 is a top view of the clip portion of the retainer kit of FIG. 13.

FIG. 18 is a side view of the clip portion of the retainer kit of FIG. 13.

FIG. 19 is an isometric view of another example of a retainer kit according to the present disclosure.

FIG. 20 is a top view of the clip portion of the retainer kit of FIG. 19.

FIG. 21 is a flowchart schematically representing methods according to the present disclosure of retaining prehung door assemblies.

### DESCRIPTION

Retainers and retainer kits for prehung door assemblies, as well as prehung door assemblies with retainers and methods of retaining prehung door assemblies, are disclosed herein.

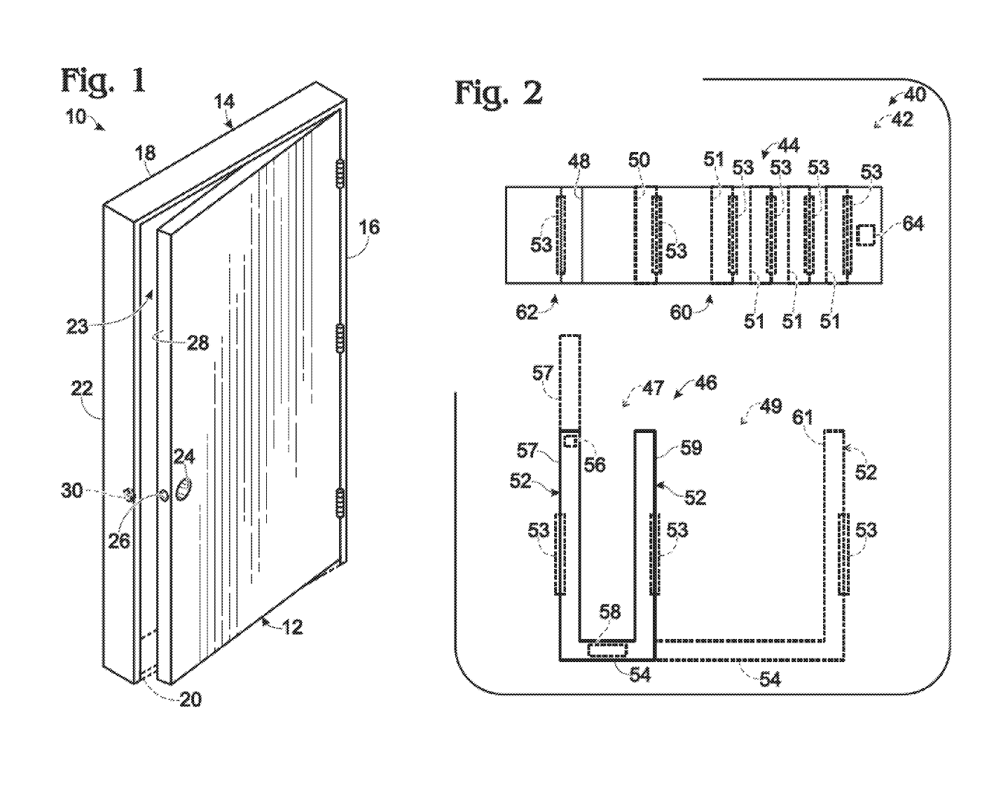

With reference first to FIG. 1, retainers and retainer kits according to the present disclosure are configured to be used with prehung door assemblies 10 to secure prehung door assemblies for shipping and installation. Prehung door assemblies 10 include a door 12 that is hinged to a door frame 14. Door 12 additionally or alternatively may be referred to as a prehung door 12, and door frame 14 additionally or alternatively may be referred to as a frame 14. Door frame 14 includes a hinge jamb 16 to which the door 12 is hinged, a header 18, and a strike jamb 22. Sometimes, door frame 14 additionally may include a sill or lower brace 20. Generally, the hinge jamb, the header, the sill, and the strike jamb, together with the lower brace, when present, collectively define a rectangular passage 23. A face bore 24 extends through and is defined in the door 12, and an edge bore 26 extends through and is defined in the door 12 from a non-hinged edge 28 of the door to the face bore 24. A strike bore 30 is defined in the strike jamb 22 of the door frame 14 and aligns with the edge bore 26 when the non-hinged edge 28 of the door is aligned with the door frame 14 and is within the passage 23. In FIG. 1, the strike bore 30 is illustrated in dashed lines, schematically representing that some prehung door assemblies 10 include a fully routed strike bore 30 that extends completely through the strike jamb 22, and that some prehung door assemblies 10 include a partially routed strike bore 30 that does not extend completely through the strike jamb 22 and that is open only on the door side of the strike jamb, that is, on the side of the strike jamb facing passage 23. The face bore 24, the edge bore 26, and the strike bore 30 collectively are configured to receive door hardware.

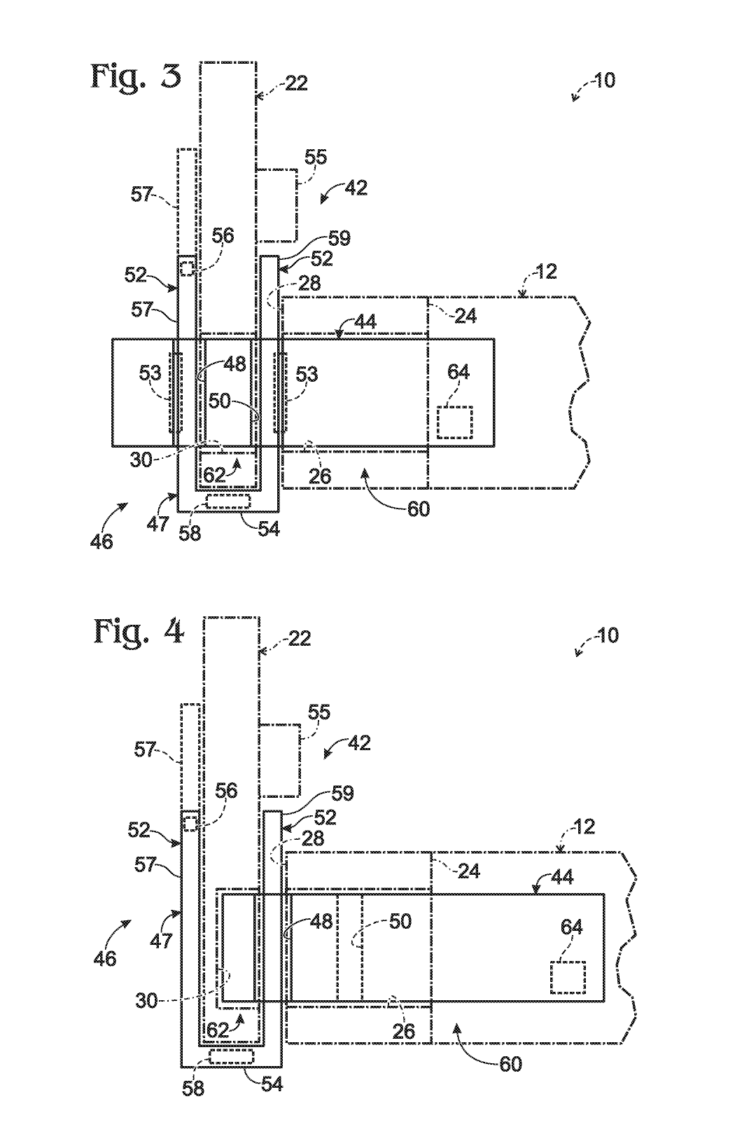

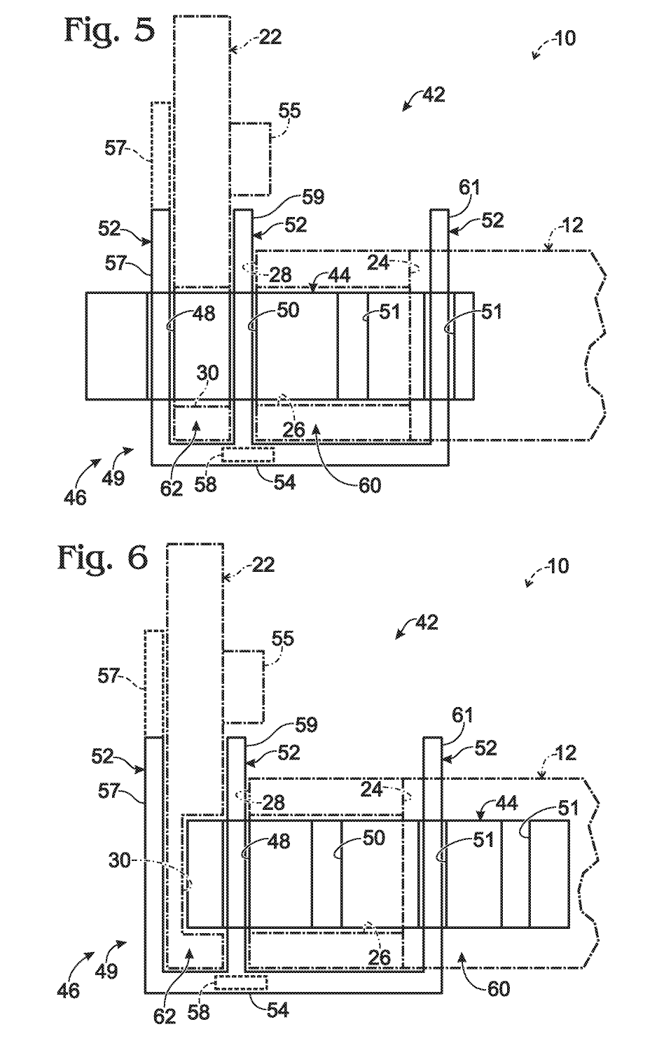

Turning now to FIGS. 2-6, FIG. 2 schematically represents retainer kits 40 whose component parts collectively define retainers 42 when installed on prehung door assemblies, FIGS. 3 and 5 schematically represent example retainers 42 installed on a prehung door assembly 10 having a fully routed strike bore 30, and FIGS. 4 and 6 schematically represent example retainers 42 installed on a prehung door assembly 10 having a partially routed strike bore 30. Generally, in FIGS. 2-6, elements that are likely to be included in a given example are illustrated in solid lines, while elements that are optional to a given example are illustrated in dashed lines. However, elements that are illustrated in solid lines are not essential to all examples of the present disclosure, and an element shown in solid lines may be omitted from a particular example without departing from the scope of the present disclosure.

As used herein, a retainer kit 40 refers to the collection of the component parts that are used to collectively define a retainer 42 when installed on a prehung door assembly 10 to operatively retain the door 12 within the passage 23 of the door frame 14. Additionally, a prehung door assembly 10 may be described as including a retainer 42 when the retainer is operatively installed. Retainers 42 additionally or alternatively may be referred to as door plugs 42. Similarly, retainer kits 40 may be referred to as door plug kits 40.

Retainer kits 40, and thus retainers 42, include a plug portion 44 and a clip portion 46. In some examples according to the present disclosure, the clip portion 46 may be described as a two-legged clip portion 47, and in other examples according to the present disclosure, the clip portion may be described as a three-legged clip portion 49. FIG. 2 schematically represents both such examples, while FIGS. 3-4 schematically illustrate retainers 42 having two legged clip-portions 47 and FIGS. 5-6 schematically illustrate retainers 42 having three-legged clip portions 49.

The plug portion is sized to extend from a face bore 24, through an edge bore 26, and into a strike bore 30 of a prehung door assembly 10, as seen with reference to FIGS. 3-6. The plug portion includes at least a first passage 48 that extends transversely through the plug portion, and in some examples optionally also includes a second passage 50 that is spaced apart from and that is generally parallel to the first passage 48. In examples of plug portions 44 configured to be used with three-legged clip portions 49, the plug portion also includes one or more third passages 51 that are further spaced apart from (relative to second passage 50) and that are generally parallel to the first passage 48.

The clip portion 46 includes at least two spaced-apart and generally parallel legs 52 and a bridge 54 that interconnects the legs 52. As mentioned, some clip portions 46 may be described as two-legged clip portions 47, and therefore include a first leg 57 and a second leg 59. Other clip portions 46 may be described as three-legged clip portions 49, and therefore may further include a third leg 61. Legs 57 and 59 are spaced and sized to extend on opposed sides of a strike jamb 22 of a prehung door assembly 10, as seen with reference to FIGS. 3-6, with one of leg 57 and leg 59 extending through the first passage 48 of the plug portion.

In some examples, as schematically and optionally illustrated in FIG. 2, one or both of the plug portion 44 and the clip portion 46 may include a feature or features 53 that are configured to restrict separation of the clip portion 46 from the plug portion 44, that is to restrict removal of one or more of the legs 52 from a corresponding passage of the plug portion 44. By restrict, it is meant that the feature or features 53, at a minimum, create resistance against separation of the clip portion 46 from the plug portion 44, but do not prevent separation of the clip portion 46 from the plug portion 44. As an illustrative, non-exclusive example, at least one of the legs 52 may include a textured surface that is configured to engage an edge of the plug portion 44 that defines or that is positioned within or adjacent to a corresponding passage. For example, the textured surface may include one or more of ramped notches, teeth, grooves, and projections that increase frictional resistance between the clip portion 46 and the plug portion 44 to restrict inadvertent separation of the clip portion 46 from the plug portion 44, but which frictional resistance is overcome when a user provides at least a threshold force to operatively separate the clip portion 46 from the plug portion 44.

Additionally or alternatively, the legs 52 of the clip portion 46 may be biased slightly away from parallel so that when one of the legs 52 extends through a corresponding passage, at least one of the legs 52 exerts a force against the plug portion 44 that restricts separation of the clip portion 46 from the plug portion 44.

In some examples, such as schematically and optionally illustrated in FIGS. 2-6, the first leg 57 may be longer than others of the legs 52. For example, when a longer first leg 57 is provided, when assembling a retainer 42 on a prehung door assembly 10, the first leg 57 may be positioned on the outside of the strike jamb 22 (opposite the door 12), such as optionally illustrated in FIGS. 3-6. Stated differently, the second leg 59 may be shorter than the first leg 57, and the shorter second leg 59 may be positioned between the strike jamb 22 and the non-hinged edge 28 of the door 12. Such a configuration may be important, for example, when the strike jamb includes a door stop molding 55 extending along the strike jamb 22 within the passage 23 of the door frame 14.

In some examples, the first leg 57 includes a feature 56 for securing the clip portion 46 to the strike jamb 22 of a prehung door assembly 10. For example, the first leg 57 may include a hole or slot for nailing or stapling the clip portion to the strike jamb 22 of a prehung door assembly 10.

In some examples, the bridge 54 may include a feature 58 configured to facilitate a user separating the clip portion 46 from the plug portion 44. More specifically, the feature 58 may be configured to be selectively engaged by a user or a tool of a user to facilitate separation of the clip portion 46 from the plug portion 44. For example, the bridge 54 may define a notch or notches that are sized to receive a hammer claw or a flat screwdriver head to permit a user to selectively pry the clip portion 46 away from the plug portion 44.

The plug portion 44 may be described as having a door region 60 and a frame region 62. The door region 60 may be sized to extend at least from the face bore 24 into the edge bore 26 of a prehung door assembly 10, and the frame region 62 may be sized to extend at least into the strike bore 30 of a prehung door assembly 10, as seen with reference to FIGS. 3-6. The first passage 48 is defined within the frame region 62, and in examples of plug portions that include a second passage 50, the second passage 50 also is defined within the frame region 62. In examples of plug portions 44 that include one or more third passages 51, the one or more third passages 51 are defined within the door region 60.

First passage 48 and optional second passage 50, when present, are positioned to facilitate use of retainer kits 40 with prehung door assemblies 10 having strike jambs 22 with fully routed strike bores 30 as well as with prehung door assemblies 10 having strike jambs 22 with partially routed strike bores 30. For example, with reference to FIGS. 4 and 6, which schematically illustrate prehung door assemblies in dash-dot lines with partially routed strike bores 30, the first passage 48 is positioned to receive the second leg 59 of the clip portion 46 on the door side of the strike jamb 22 between the strike jamb 22 and the non-hinged edge 28, while the first leg 57 extends on the opposed side of the strike jamb opposite the non-hinged edge 28. In this configuration, a second passage 50 is not required; however, a plug portion 44 having a second passage 50 may be used and will still function in the configurations illustrated in FIGS. 4 and 6 to operatively retain the non-hinged edge 28 adjacent to the strike jamb 22. When so assembled, the retainer kit 40 may be described as a retainer 42 having a partially routed strike bore assembly, or configuration. Moreover, a retainer kit 40 may be used in the same manner with prehung door assemblies 10 having fully routed strike bores 30.

With reference to FIGS. 3 and 5, which schematically illustrate prehung door assemblies 10 in dash-dot lines with fully routed strike bores 30, the first passage 48 is positioned to receive the first leg 57 of the clip portion 46 adjacent to the strike jamb 22 on the side of the strike jamb opposite the non-hinged edge 28, and the second passage 50 is positioned to receive the second leg 59 of the clip portion 46 on the door side of the strike jamb 22 between the strike jamb 22 and the non-hinged edge 28. When so assembled, the retainer kit 40 may be described as a retainer 42 having a fully routed strike bore assembly, or configuration.

As seen with reference to FIGS. 5-6, when the plug portion 44 includes one or more third passages 51, it is configured for use with a three-legged clip portion 49. More specifically, regardless of whether the retainer kit is being used in connection with a fully routed strike bore 30 or a partially routed strike bore 30, the one or more third passages 51 are positioned to receive a third leg 59 of the clip portion 49 via the face bore 24 of the prehung door assembly 10. In the schematically illustrated examples of FIGS. 5-6, two third passages 51 are optionally illustrated, and with reference to both of FIGS. 5-6, in such a configuration, the two third passages 51 are spaced apart by the same distance as spacing between the first passage 48 and the second passage 50. Accordingly, the same clip portion 49 and same plug portion 44 may be used with both fully routed strike bores and partially routed strike bores. While only two third passages 51 are illustrated in the examples of FIGS. 5-6, any number of third passages 51 may be provided, including one, two, three, four, or more than four third passages 51, as schematically and optionally illustrated in FIG. 2. For example, providing more than two third passages 51 may permit for a single plug portion 44 to be used with prehung door assemblies 10 having different backsets (i.e., the distance from the non-hinged edge 28 of the door 12 to the center of the face bore 24. Stated differently, such a single plug portion 44 may be used with prehung door assemblies 10 having different lengths of edge bores 26.

In some examples, the door region 60 of the plug portion 44 has a circular perpendicular cross-sectional profile, such as to fit a circular edge bore 26.

In some examples of plug portions 44, the frame region 62 has a perpendicular cross-sectional profile that is shaped to fit a circular strike bore 30, a rectangular strike bore 30, or either of a circular strike bore or a rectangular strike bore. For example, the perpendicular cross-sectional profile of the frame region 62 may include opposed arcuate sides that correspond to a circular strike bore and opposed linear sides that correspond to a rectangular strike bore. In such examples, the frame region 62 has two opposed curved sides and two opposed planar sides. In some such examples, the first passage 48, and the optional second passage 50, when present, may extend through the opposed planar sides of the frame region 62.

In some examples, the plug portion 44 may include at least one continuous smooth surface that spans the entire length of the plug portion 44. When present, the continuous smooth surface may facilitate insertion into and translation through the edge bore 26 of prehung door assemblies 10. In some examples, the plug portion 44 may include two continuous smooth surfaces that span the entire length of the plug portion 44. For example, in examples of plug portions 44 that include a door region 60 that has a circular perpendicular cross-sectional profile and a frame region 62 that has a perpendicular cross-sectional profile with opposed arcuate sides and opposed linear sides, the opposed arcuate sides may form continuous smooth surfaces with the circular profile of the door region, whereas the opposed linear sides do not.

As schematically represented in FIGS. 2-4, some examples of plug portions 44 optionally may include a feature 64 that provides a visual indicator to a user when the plug portion 44 extends into the face bore 24 of a prehung door assembly 10. Additionally or alternatively, the feature 64 may include or define a hole that is sized or otherwise configured to receive a screwdriver shaft, or other elongate structure, such as to serve as a temporary door handle when a retainer 42 is operatively installed on a prehung door assembly 10.

In some examples of retainer kits 40, the plug portion 44 may be hollow. In some examples of retainer kits 40, the plug portion 44 may define a monolithic structure, that is, may be a single piece of material and not an assembly of more than one part. Plug portions 44 may be constructed of any suitable material from any suitable process. For example, plug portions 44 may be constructed of plastic, metal, or wood. Plug portions 44 may be molded, machined, or 3D-printed, as examples.

In some examples of retainer kits 40, the clip portion 46 may define a monolithic structure, that is, may be a single piece of material and not an assembly of more than one part. Clip portions 46 may be constructed of any suitable material from any suitable process. For example, clip portions 46 may be constructed of plastic, metal, or wood. Clip portions 46 may be molded, machined, or 3D-printed, as examples.

In some examples, retainer kits 40 and retainers 42 may be configured for, and/or well suited for, use with doors 12 that are heavy, such as solid core doors, entry doors, etc. That is, retainers 42 when assembled on a prehung door assembly 10 may be constructed so that the weight of the door 12 during shipment and installation does not impart a destructive force on the retainer 42 that might otherwise break a prior art retainer.

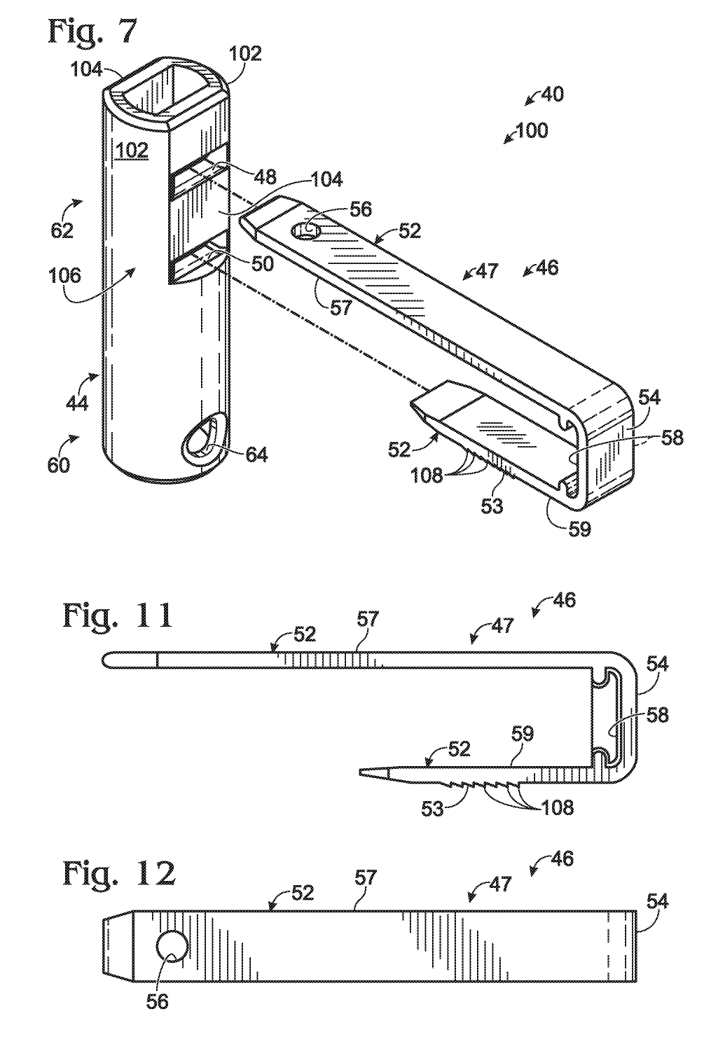

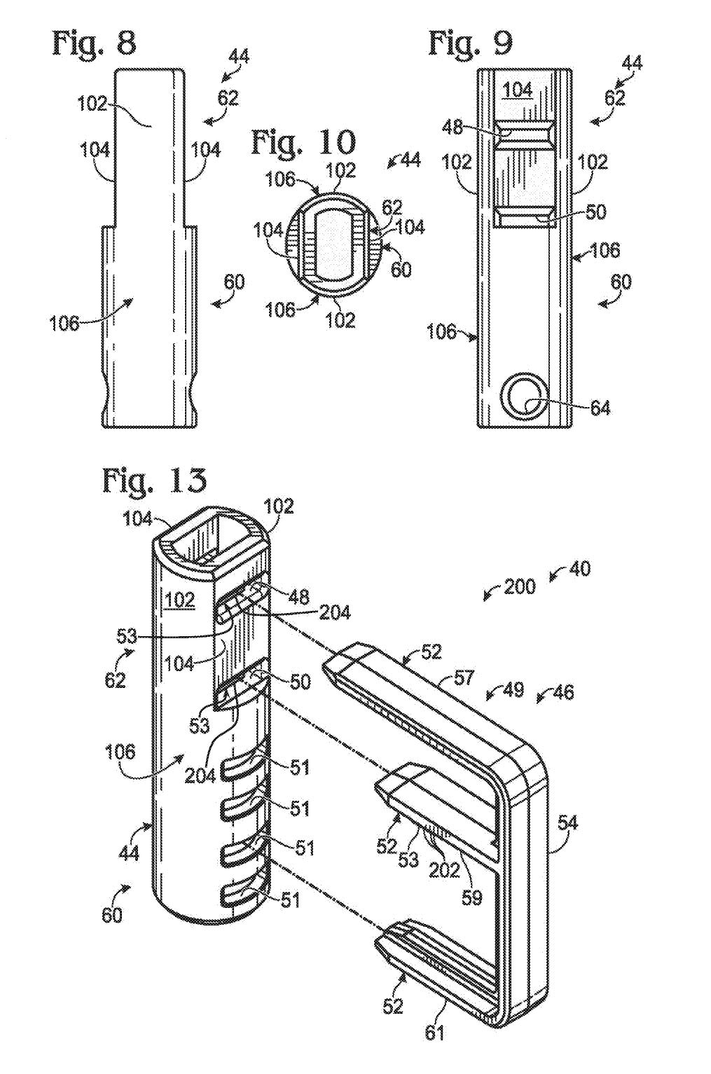

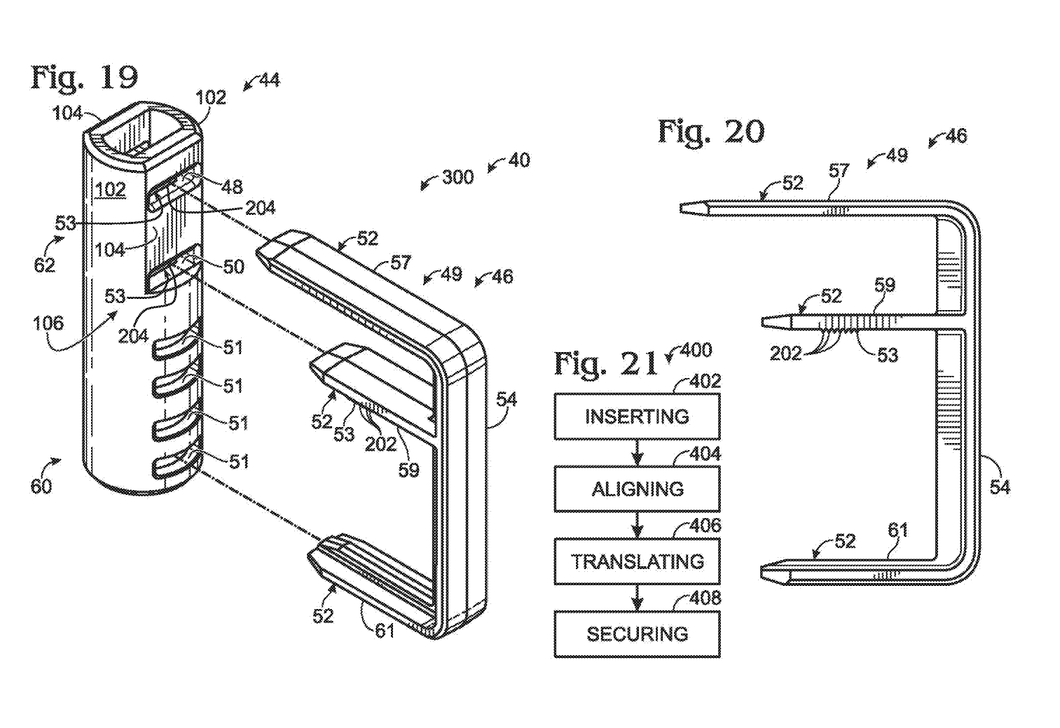

Turning now to FIGS. 7-20, three illustrative, non-exclusive examples of retainer kits 40 and their component parts are illustrated, with the example retainer kit 40 of FIGS. 7-12 indicated as and referred to herein as retainer kit 100, with the example retainer kit 40 of FIGS. 13-18 indicated as and referred to herein as retainer kit 200, and with the example retainer kit 40 of FIGS. 19-20 indicated as and referred to herein as retainer kit 300. Where appropriate, the reference numerals from the schematic illustrations of FIGS. 2-6 are used to designate corresponding parts of the retainer kits 100, 200, and 300; however, retainer kits 100, 200, and 300 are non-exclusive and do not limit retainer kits 40 and thus retainers 42 to the illustrated example of FIGS. 7-20. That is, retainer kits 40 and retainers 42 are not limited to the specific examples of FIGS. 7-20, and retainer kits 40 and retainers 42 may incorporate any number of the various aspects, configurations, characteristics, properties, etc. of retainer kits 40 and retainers 42 that are illustrated in and discussed with reference to the schematic representations of FIGS. 2-6 and/or the example retainer kits 100, 200, and 300 of FIGS. 7-20, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to retainer kits 100, 200, and 300; however, it is within the scope of the present disclosure that the previously discussed features, variants, etc. may be utilized with or as a variant on retainer kits 100, 200, and 300.

As seen in FIGS. 7-10, retainer kit 100 is an example of a retainer kit 40 whose plug portion 44 is defined by a hollow monolithic structure and includes both of a first passage 48 and a second passage 50 but that does not include a third passage 51. Accordingly, as seen in FIGS. 7 and 11, retainer kit 100 is an example of a retainer kit 40 whose clip portion 46 is a two-legged clip portion 47.

Also, the plug portion 44 of retainer kit 100 includes a door region 60 having a circular perpendicular cross-sectional profile and a frame region 62 that has opposed curved sides 102 and opposed planar sides 104. Accordingly, the plug portion 44 of retainer kit 100 is configured to be used with prehung door assemblies having circular strike bores as well as with prehung door assemblies having rectangular strike bores. Moreover, the opposed curved sides 102 are congruous with the circular profile of the door region 60 of the plug portion, and therefore, the plug portion 44 of the retainer kit 100 is an example of a plug portion that includes two continuous smooth surfaces 106 that span the entire length of the plug portion 44 and facilitate easy insertion into and translation through the edge bore of a prehung door assembly.

The plug portion 44 of retainer kit 100 also is an example of a plug portion that includes a feature 64 in the form of a hole that may provide a visual indicator to a user when the plug portion extends into the face bore of a prehung door assembly. Moreover, the hole is sized to receive a screwdriver shaft, or other elongate structure, to serve as a temporary door handle when the plug portion is operatively positioned on a prehung door assembly.

As seen in FIGS. 7 and 11-12, retainer kit 100 is an example of a retainer kit 40 whose clip portion 46 is defined by a monolithic structure with a longer first leg 57 and a shorter second leg 59. The longer leg includes a feature 56 in the form of a hole that may be used to nail or staple the clip portion to the outer side of a strike jamb of a door frame.

The clip portion 46 of retainer kit 100 also is an example of a clip portion that includes a feature 53 in the form of ramped notches 108 that operatively engage an edge of one of the first passage 48 or the second passage 50 of the plug portion when coupled together, depending on the assembly of a retainer from the retainer kit 100, to thereby restrict separation of the clip portion from the plug portion. Moreover, the clip portion of retainer kit 100 also includes features 58 in the form of opposed notches that are sized for a user to operatively pry the clip portion away from the plug portion, such as with a flathead screwdriver, to overcome the friction between the ramped notches and the edge of one of the first passage and the second passage of the plug portion.

Turning now to FIGS. 13-18, and first with reference to FIGS. 13-16, retainer kit 200 is an example of a retainer kit 40 whose plug portion 44 is defined by a hollow monolithic structure and includes both of a first passage 48 and a second passage 50, as well as four third passages 51. Accordingly, as seen in FIGS. 13 and 17, retainer kit 200 is an example of a retainer kit 40 whose clip portion 46 is a three-legged clip portion 49.

Similar to the plug portion of retainer kit 100, discussed above, the plug portion 44 of retainer kit 200 includes a door region 60 having a circular perpendicular cross-sectional profile and a frame region 62 that has opposed curved sides 102 and opposed planar sides 104. Accordingly, the plug portion 44 of retainer kit 200 is configured to be used with prehung door assemblies having circular strike bores as well as with prehung door assemblies having rectangular strike bores. Moreover, the opposed curved sides 102 are congruous with the circular profile of the door region 60 of the plug portion, and therefore, the plug portion 44 of the retainer kit 200 is an example of a plug portion that includes two continuous smooth surfaces 106 that span the entire length of the plug portion 44 and facilitate easy insertion into and translation through the edge bore of a prehung door assembly.

As seen in FIGS. 13 and 17-18, retainer kit 200 is an example of a retainer kit 40 whose clip portion 46 is defined by a monolithic structure with a longer first leg 57, a shorter second leg 59, and a third leg 61 that is the same length as the second leg.

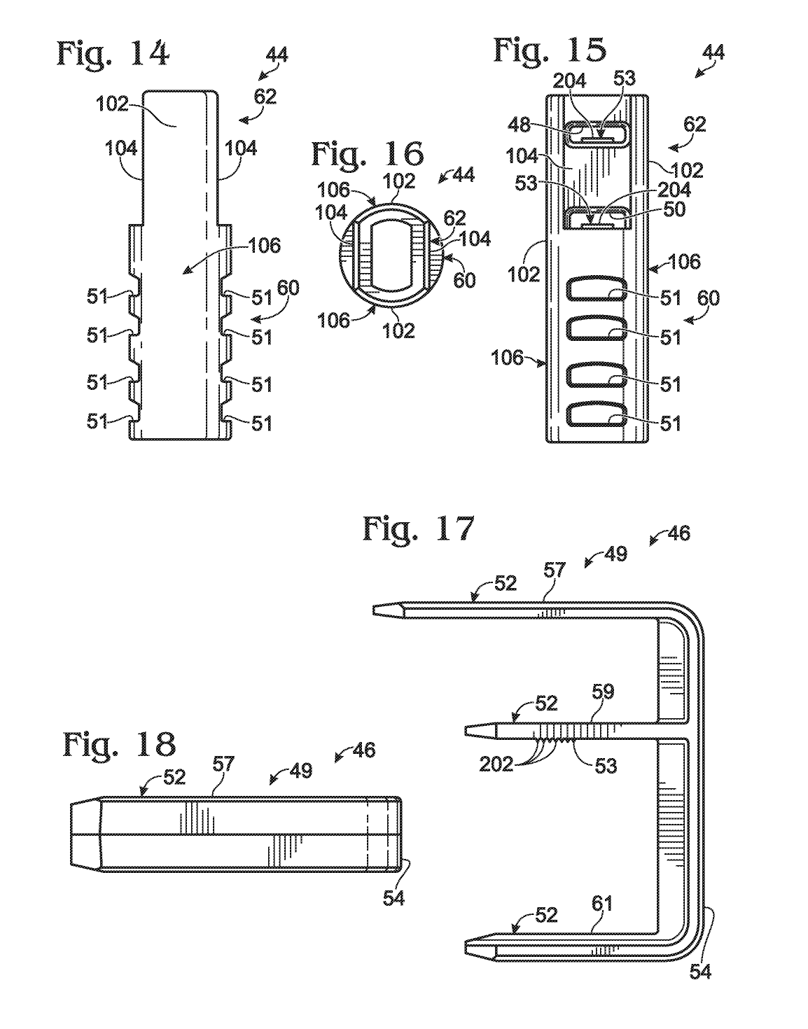

The clip portion 46 of retainer kit 200 also is an example of a clip portion that includes a feature 53 in the form of teeth 202 projecting from one side of the second leg 59, as best seen in FIG. 17. The plug portion 44 of retainer kit 200 is an example of a plug portion that includes two features 53 in the form of tabs 204 projecting into the first passage 48 and the second passage 50, as best seen in FIG. 15. The tabs are positioned to operatively engage the teeth 202 of the second leg 59 of the clip portion to thereby restrict separation of the clip portion from the plug portion when the second leg extends through one of the first passage or the second passage.

Turning now to FIGS. 19-20, and with continued reference to FIGS. 14-16, retainer kit 300 is an example of a retainer kit 40 whose plug portion 44 is defined by a hollow monolithic structure and includes both of a first passage 48 and a second passage 50, as well as four third passages 51. Moreover, the plug portion 44 of retainer kit 300 is identical to the plug portion of retainer kit 200, and thus FIGS. 14-16 likewise illustrate the plug portion of retainer kit 300. As seen in FIGS. 19 and 20, and also similar to retainer kit 200, retainer kit 300 is an example of a retainer kit 40 whose clip portion 46 is a three-legged clip portion 49.

Similar to the plug portions of retainer kits 100 and 200, discussed above, the plug portion 44 of retainer kit 300 includes a door region 60 having a circular perpendicular cross-sectional profile and a frame region 62 that has opposed curved sides 102 and opposed planar sides 104. Accordingly, the plug portion 44 of retainer kit 300 is configured to be used with prehung door assemblies having circular strike bores as well as with prehung door assemblies having rectangular strike bores. Moreover, the opposed curved sides 102 are congruous with the circular profile of the door region 60 of the plug portion, and therefore, the plug portion 44 of the retainer kit 300 is an example of a plug portion that includes two continuous smooth surfaces 106 that span the entire length of the plug portion 44 and facilitate easy insertion into and translation through the edge bore of a prehung door assembly.

As seen in FIGS. 19 and 20, retainer kit 300 is an example of a retainer kit 40 whose clip portion 46 is defined by a monolithic structure with a longer first leg 57, a shorter second leg 59, and a third leg 61 that is the same length as the second leg.

Similar to retainer kit 200, the clip portion 46 of retainer kit 300 also is an example of a clip portion that includes a feature 53 in the form of teeth 202 projecting from one side of the second leg 59, as best seen in FIG. 20. The plug portion 44 of retainer kit 300 is an example of a plug portion that includes two features 53 in the form of tabs 204 projecting into the first passage 48 and the second passage 50, as best seen in FIG. 15. The tabs are positioned to operatively engage the teeth 202 of the second leg 59 of the clip portion to thereby restrict separation of the clip portion from the plug portion when the second leg extends through one of the first passage or the second passage.

Comparing retainer kit 200 and retainer kit 300, the plug portions 44 are identically sized and constructed; however, the clip portion 46 of retainer kit 200 is smaller than the clip portion 46 of retainer kit 300. More specifically, the third leg 61 of the clip portion 46 of retainer kit 200 is spaced from the second leg 59 such that it will be inserted into the first (i.e. closest to second passage 50) of the four third passages 51 when the retainer kit 200 is used with a partially routed strike bore 30, and such that it will be inserted into the third of the four third passages 51 when the retainer kit 200 is used with a fully routed strike bore 30. In contrast, the third leg 61 of the clip portion 46 of retainer kit 300 is spaced from the second leg 59 such that it will be inserted into the second of the four third passages 51 when the retainer kit 300 is used with a partially routed strike bore 30, and such that it will be inserted into the fourth of the four third passages 51 when the retainer kit 300 is used with a fully routed strike bore 30.

FIG. 21 schematically provides a flowchart that represents illustrative, non-exclusive examples of methods 400 according to the present disclosure for retaining prehung door assemblies. The methods and steps illustrated in FIG. 21 are not limiting and other methods and steps are within the scope of the present disclosure, including methods having greater than or fewer than the number of steps illustrated. Methods 400 may be implemented with retainer kits 40 according to the present disclosure, but also may be implemented with other retainer kits that are not disclosed herein.

As schematically illustrated in FIG. 21, methods 400 include inserting 402 a plug portion of a retainer kit into an edge bore of a door of the prehung door assembly so that the plug portion extends into a face bore of the door; following the inserting 402, aligning 404 the door with a strike jamb of the prehung door assembly; following the aligning 404, translating 406 the plug portion into a strike bore of the strike jamb of the prehung door assembly so that the plug portion extends from the face bore, through the edge bore, and into the strike bore; and following the translating 406, securing 408 the plug portion in place with a clip portion of the retainer kit. In some methods 400, but not required in all methods 400, the plug portion may be a plug portion 44 of a retainer kit 40 according to the present disclosure, and the clip portion may be a clip portion 46 of a retainer kit 40 according to the present disclosure.

Illustrative, non-exclusive examples of inventive subject matter according to the present disclosure are described in the following enumerated paragraphs:

A. A retainer kit for a prehung door assembly, the retainer kit comprising:

a plug portion sized to extend from a face bore, through an edge bore, and into a strike bore of the prehung door assembly, wherein the plug portion includes at least a first passage extending transversely through the plug portion; and

a clip portion including two or more legs including a first leg and a second leg that is spaced apart from and generally parallel to the first leg, and a bridge that interconnects the first leg and the second leg, wherein the first leg and the second leg are spaced and sized to extend on opposed sides of a strike jamb of the prehung door assembly, with one of the first leg and the second leg extending through the first passage of the plug portion.

A1. The retainer kit of paragraph A, wherein the plug portion includes a second passage that is spaced apart from and generally parallel to the first passage, and wherein the first leg and the second leg of the clip portion are spaced and sized to extend on opposed sides of the strike jamb of the prehung door assembly, with the first leg extending through the first passage of the plug portion and the second leg extending through the second passage of the plug portion.

A2. The retainer kit of any of paragraphs A-A1,

wherein the plug portion includes a/the second passage that is spaced apart from and generally parallel to the first passage; and

wherein the retainer kit is configured to be assembled into a first retainer having a fully routed strike bore assembly and into a second retainer having a partially routed strike bore assembly, wherein in the fully routed strike bore assembly, the first leg extends through the first passage of the plug portion and the second leg extends through the second passage of the plug portion, and wherein in the partially routed strike bore assembly, the second leg extends through the first passage of the plug portion.

A3. The retainer kit of any of paragraphs A-A2, wherein one or both of the plug portion and the clip portion include a feature configured to restrict separation of the clip portion from the plug portion.

A4. The retainer kit of any of paragraphs A-A3, wherein at least one of the two or more legs of the clip portion includes a textured surface configured to engage an edge of the plug portion that defines or that is positioned within or adjacent to the first passage, and optionally, when depending from any of paragraphs A1-A2, to engage an edge of the plug portion that defines or that is positioned within or adjacent to the second passage.

A4.1. The retainer kit of paragraph A4, wherein the textured surface includes one or more of ramped notches, teeth, grooves, and projections.

A5. The retainer kit of any of paragraphs A-A4.1, wherein at least one of the two or more legs of the clip portion is biased slightly away from parallel so that when one of the first leg and the second leg extends through the first passage, and optionally, when depending from any of paragraphs A1-A2, when the other of the first leg and the second leg extends through the second passage, at least one of the first leg and the second leg exerts a force against the plug portion that restricts separation of the clip portion from the plug portion.

A6. The retainer kit of any of paragraphs A-A5, wherein the first leg is longer than the second leg.

A7. The retainer kit of any of paragraphs A-A6, wherein the first leg includes a feature for securing the clip portion to the strike jamb of the prehung door assembly.

A8. The retainer kit of any of paragraphs A-A7, wherein the first leg of the clip portion includes a hole or slot for nailing or stapling the clip portion to the strike jamb of the prehung door assembly.

A9. The retainer kit of any of paragraphs A-A8, wherein the bridge includes a feature configured to be selectively engaged to facilitate separation of the clip portion from the plug portion.

A10. The retainer kit of any of paragraphs A-A9, wherein the bridge defines a notch sized to receive a hammer claw or a flat screwdriver head for selective prying of the clip portion away from the plug portion.

A11. The retainer kit of any of paragraphs A-A10, wherein the plug portion includes a door region and a frame region, wherein the door region is sized to extend at least from the face bore into the edge bore of the prehung door assembly, and wherein the frame region is sized to extend into the strike bore of the prehung door assembly.

A11.1. The retainer kit of paragraph A11, wherein the first passage is, and, when depending from any of paragraphs A1-A2, the second passage is, defined in the frame region of the plug portion.

A11.1.1. The retainer kit of paragraph A11.1, wherein the first passage is, and, when depending from any of paragraphs A1-A2, the second passage is, positioned to facilitate use of the retainer kit with a prehung door assembly having a fully routed strike bore and with a prehung door assembly having a partially routed strike bore.

A11.2. The retainer kit of any of paragraphs A11-A11.1.1, wherein the door region has a circular perpendicular cross-sectional profile.

A11.3. The retainer kit of any of paragraphs A11-A11.2, wherein the frame region has a perpendicular cross-sectional profile shaped to fit a circular strike bore and a rectangular strike bore.

A11.3.1. The retainer kit of paragraph A11.3, wherein the perpendicular cross-sectional profile of the frame region includes opposed arcuate sides and opposed linear sides.

A11.3.1.1 The retainer kit of paragraph A11.3.1, wherein the first passage extends, and, when depending from any of paragraphs A1-A2, the second passage extends, through the opposed linear sides.

A12. The retainer kit of any of paragraphs A-A11.3.1.1, wherein the plug portion includes at least one continuous smooth surface that spans an entire length of the plug portion, and optionally two continuous smooth surfaces that span an entire length of the plug portion.

A13. The retainer kit of any of paragraphs A-A12, wherein the plug portion includes a feature, optionally a/the hole, configured to provide a visual indicator when the plug portion extends into the face bore of the prehung door assembly.

A14. The retainer kit of any of paragraphs A-A13, wherein the plug portion includes a feature, optionally a hole, configured to receive a screwdriver shaft to serve as a temporary door handle when the retainer kit is installed on the prehung door assembly.

A15. The retainer kit of any of paragraphs A-A14, wherein the plug portion is hollow.

A16. The retainer kit of any of paragraphs A-A15, wherein the plug portion defines a monolithic structure.

A17. The retainer kit of any of paragraphs A-A16, wherein the clip portion defines a monolithic structure.

A18. The retainer kit of any of paragraphs A-A17, wherein the retainer kit is configured to define a retainer for use with a/the prehung door assembly having a/the fully routed strike bore and with a/the prehung door assembly having a/the partially routed strike bore.

A19. The retainer kit of any of paragraphs A1-A17 when depending from any of paragraphs A1-A2, wherein the plug portion further includes one or more third passages that are spaced apart from and generally parallel to the second passage, wherein the two or more legs further includes a third leg that is spaced apart from and generally parallel to the second leg, wherein the bridge interconnects the first leg, the second leg, and the third leg, and wherein the third leg is spaced and sized to extend through one of the third passages of the plug portion when the one of the first leg and the second leg extends through the first passage of the plug portion.

A19.1. The retainer kit of paragraph A19, wherein the plug portion includes at least two third passages.

A20. The retainer kit of any of paragraphs A-A19.1, wherein the clip portion is a distinct component from the plug portion.

A21. The retainer kit of any of paragraphs A-A20, wherein the clip portion and the plug portion are separately constructed.

A22. The retainer kit of any of paragraphs A-A21, wherein the clip portion is untethered from the plug portion.

B. A prehung door assembly, comprising:

a door frame, including a hinge jamb, a header, and a strike jamb that defines a strike bore;

a door hinged to the hinge jamb, the door defining a face bore and an edge bore that is aligned with the strike bore; and

a retainer formed from the retainer kit of any of paragraphs A-A22, wherein the plug portion extends from the face bore, through the edge bore, and into the strike bore.

B1. The prehung door assembly of paragraph B when depending from any of paragraphs A1-A2,

wherein the strike bore is a fully routed strike bore; and

wherein the plug portion extends from the face bore, through the edge bore, and through the strike bore, wherein the first passage and the second passage of the plug portion straddle opposed sides of the strike jamb of the door frame, and wherein the first leg and the second leg of the clip portion extend through the first passage and the second passage, respectively.

B2. The prehung door assembly of paragraph B,

wherein the strike bore is a partially routed strike bore; and

wherein the plug portion extends from the face bore, through the edge bore, and into the strike bore, wherein the first passage of the plug portion is positioned adjacent to a door side of the strike jamb of the door frame, and wherein the first leg and the second leg of the clip portion straddle opposed sides of the strike jamb with the first leg extending through the first passage.

B3. The prehung door assembly of any of paragraphs B-B2 when depending from paragraph A19, wherein the third leg of the clip portion extends through the face bore and one of the one or more third passages of the plug portion.

C. A method of retaining a prehung door assembly, the method comprising:

inserting a plug portion into an edge bore and a face bore of a door of the prehung door assembly;

following the inserting, aligning the door with a strike jamb of the prehung door assembly;

following the aligning, translating the plug portion into a strike bore of the prehung door assembly so that the plug portion extends from the face bore, through the edge bore, and into the strike bore; and

following the translating, securing the plug portion in place with a clip portion.

C1. The method of paragraph C, wherein the plug portion and the clip portion are of the retainer kit of any of paragraphs A-A22.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A retainer kit for a prehung door assembly, the retainer kit comprising:
a plug portion sized to extend from a face bore, through an edge bore, and into a strike bore of a prehung door assembly, wherein the plug portion includes a first passage extending transversely through the plug portion and a second passage that is spaced apart from and generally parallel to the first passage; and
a clip portion including two or more legs including a first leg and a second leg that is spaced apart from and generally parallel to the first leg, and a bridge that interconnects the first leg and the second leg, wherein the first leg and the second leg are spaced and sized to extend on opposed sides of a strike jamb of the prehung door assembly, with one of the first leg and the second leg extending through the first passage of the plug portion;
wherein the retainer kit is configured to be assembled into a first retainer having a fully routed strike bore assembly and into a second retainer having a partially routed strike bore assembly, wherein in the fully routed strike bore assembly, the first leg extends through the first passage of the plug portion and the second leg extends through the second passage of the plug portion, and wherein in the partially routed strike bore assembly, the second leg extends through the first passage of the plug portion.

2. The retainer kit of claim 1, wherein one or both of the plug portion and the clip portion include a feature configured to restrict separation of the clip portion from the plug portion.

3. The retainer kit of claim 1, wherein at least one of the two or more legs of the clip portion includes a textured surface configured to engage an edge of the plug portion that defines or that is positioned within or adjacent to the first passage and to engage an edge of the plug portion that defines or that is positioned within or adjacent to the second passage.

4. The retainer kit of claim 1, wherein the bridge includes a feature configured to be selectively engaged to facilitate separation of the clip portion from the plug portion.

5. The retainer kit of claim 1, wherein the plug portion includes a door region and a frame region, wherein the door region is sized to extend at least from the face bore into the edge bore of the prehung door assembly, and wherein the frame region is sized to extend into the strike bore of the prehung door assembly.

6. The retainer kit of claim 5, wherein the first passage and the second passage are defined in the frame region of the plug portion.

7. The retainer kit of claim 5, wherein the door region has a circular perpendicular cross-sectional profile.

8. The retainer kit of claim 7, wherein the frame region has a perpendicular cross-sectional profile shaped to fit a circular strike bore and a rectangular strike bore, and wherein the perpendicular cross-sectional profile of the frame region includes opposed arcuate sides and opposed linear sides.

9. The retainer kit of claim 8, wherein the first passage and the second passage extend through the opposed linear sides.

10. The retainer kit of claim 8, wherein the plug portion includes two continuous smooth surfaces that span an entire length of the plug portion.

11. The retainer kit of claim 1, wherein the plug portion is hollow.

12. The retainer kit of claim 1, wherein the plug portion further includes one or more third passages that are spaced apart from and generally parallel to the second passage, wherein the two or more legs further includes a third leg that is spaced apart from and generally parallel to the second leg, wherein the bridge interconnects the first leg, the second leg, and the third leg, and wherein the third leg is spaced and sized to extend through one of the third passages of the plug portion when the one of the first leg and the second leg extends through the first passage of the plug portion.

13. The retainer kit of claim 12, wherein the plug portion includes four third passages.

14. A prehung door assembly, comprising:
a door frame, including a hinge jamb, a header, and a strike jamb that defines a strike bore;
a door hinged to the hinge jamb, the door defining a face bore and an edge bore that is aligned with the strike bore; and
a retainer formed from the retainer kit of claim 1, wherein the plug portion extends from the face bore, through the edge bore, and into the strike bore.

15. A method of retaining a prehung door assembly, the method comprising:
providing the retainer kit of claim 1;
inserting the plug portion into an edge bore of a door of the prehung door assembly so that the plug portion extends into a face bore of the door;
following the inserting, aligning the door with a strike jamb of the prehung door assembly;
following the aligning, translating the plug portion into a strike bore of the prehung door assembly so that the plug portion extends from the face bore, through the edge bore, and into the strike bore; and
following the translating, securing the plug portion in place with the clip portion by inserting one of the first leg and the second leg through the first passage.

16. A retainer kit for a prehung door assembly, the retainer kit comprising:
a plug portion sized to extend from a face bore, through an edge bore, and into a strike bore of a prehung door assembly, wherein the plug portion includes at least a first passage extending transversely through the plug portion, a second passage that is spaced apart from and generally parallel to the first passage, and one or more third passages that are spaced apart from and generally parallel to the second passage; and
a clip portion including a first leg, a second leg that is spaced apart from and generally parallel to the first leg, a third leg that is spaced apart from and generally parallel to the second leg, and a bridge that interconnects the first leg, the second leg, and the third leg, wherein the first leg and the second leg of the clip portion are spaced and sized to extend on opposed sides of a strike jamb of the prehung door assembly with the first leg extending through the first passage of the plug portion, the second leg extending through the second passage of the plug portion, and the third leg extending through one of the one or more third passages of the plug portion.

17. The retainer kit of claim 16, wherein the one or more third passages includes at least two third passages.

18. A prehung door assembly, comprising:
a door frame, including a hinge jamb, a header, and a strike jamb that defines a strike bore;
a door hinged to the hinge jamb, the door defining a face bore and an edge bore that is aligned with the strike bore; and
a retainer formed from the retainer kit of claim 16, wherein the plug portion extends from the face bore, through the edge bore, and into the strike bore.

19. A method of retaining a prehung door assembly, the method comprising:
providing the retainer kit of claim 16;
inserting the plug portion into an edge bore and a face bore of a door of the prehung door assembly;
following the inserting, aligning the door with a strike jamb of the prehung door assembly;
following the aligning, translating the plug portion into a strike bore of the prehung door assembly so that the plug portion extends from the face bore, through the edge bore, and into the strike bore; and
following the translating, securing the plug portion in place with the clip portion by inserting one of the first leg and the second leg through the first passage and by inserting the third leg through one of the one or more third passages.

20. A retainer kit for a prehung door assembly, the retainer kit comprising:
means for extending from a face bore, through an edge bore, and into a strike bore of the prehung door assembly; and
means for retaining the means for extending in the face bore, the edge bore, and the strike bore to prevent to a prehung door of the prehung door assembly from freely swinging relative to a door frame of the prehung door assembly.
